(19) United States
(12) Patent Application Publication
(10) Pub. No.: US 2008/0048818 A1
(43) Pub. Date: Feb. 28, 2008

(54) Transformers with improved voltage-step-down ratios and DC-to-DC power converters employing same

(76) Inventors: Hong Mao, N. Andover, MA (US); Bradley Higgings, Littleton, MA (US); Liangbin Yao, Orlando, FL (US)

Correspondence Address: HARNESS, DICKEY, & PIERCE, P.L.C, 7700 BONHOMME, STE 400, ST. LOUIS, MO, 63105, US

(21) Appl. No.: 11/510,770

(22) Filed: Aug. 25, 2006

(51) Int. Cl. H01F 27/24

(52) U.S. Cl. 336/213

(57) ABSTRACT

A transformer includes a primary winding, a secondary winding, and a transformer core having a first leg, a second leg and a third leg. The second leg is positioned between the first leg and the third leg, and the primary winding is wound around the first leg, the second leg and the third leg. A power converter includes a primary winding, a secondary winding, a rectifier coupled to the secondary winding, and a transformer core having a first leg, a second leg and a third leg. The second leg is positioned between the first leg and the third leg, and the primary winding is wound around the first leg, the second leg and the third leg.

### FIELD

The present disclosure relates to dc-dc power converters and transformers therefor.

### BACKGROUND

The statements in this section merely provide background information related to the present disclosure and may not constitute prior art.

Transformers for power converters having low output voltages, such as isolated point-of-load (POL) DC-to-DC power converters for supplying power to integrated circuits, can require a high voltage step-down ratio. Typically, these transformers include a primary winding and a secondary winding wound around a transformer core having three or more legs, such as an EE or an EI core. Since the voltage step-down ratio is typically determined by the number of turns of the primary winding and the secondary winding, achieving a high step-down ratio commonly requires a large number of turns of the primary winding and a small number of turns, typically one, of the secondary winding.

As recognized by the inventors, however, having a large number of turns of the primary winding can result in significant copper losses and large leakage inductances which can lead to lower efficiency. In addition, in power converters having high output currents, the copper losses in the secondary winding can also be significant.

Furthermore, in planar transformers where the primary winding typically comprises copper traces positioned on a printed circuit board, having a large number of turns of the primary winding can result in poor window utilization due to clearance requirements between traces.

### SUMMARY

In accordance with one aspect of the present disclosure, a transformer includes a primary winding, a secondary winding, and a transformer core having a first leg, a second leg and a third leg. The second leg is positioned between the first leg and the third leg, and the primary winding is wound around the first leg, the second leg and the third leg.

In accordance with another aspect of the present disclosure, a power converter includes a primary winding, a secondary winding, a rectifier coupled to the secondary winding, and a transformer core having a first leg, a second leg and a third leg. The second leg is positioned between the first leg and the third leg, and the primary winding is wound around the first leg, the second leg and the third leg.

In accordance with yet another aspect of the present disclosure, a resonant power converter includes a transformer having a primary winding, a secondary winding, and a transformer core having a first leg, a second leg and a third leg. The second leg is positioned between the first leg and the third leg, and the primary winding is wound around the second leg.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross-sectional view of a transformer according to one embodiment of the present disclosure.

FIG. 2 is an equivalent magnetic circuit of the transformer of FIG. 1.

FIG. 3 is a circuit diagram of a power converter employing the transformer of FIG. 1 according to another embodiment of the present disclosure.

FIG. 4 is a cross-sectional view of a transformer according to yet another embodiment of the present disclosure.

FIG. 5 is a circuit diagram of a power converter employing the transformer of FIG. 4 according to another embodiment of the present disclosure.

FIG. 6 is a circuit diagram of a power converter employing the transformer of FIG. 4 according to yet another embodiment of the present disclosure.

FIG. 7 is a circuit diagram of a resonant power converter employing the transformer of FIG. 4 according to another embodiment of the present disclosure.

FIG. 8 is a circuit diagram of a resonant power converter employing the transformer of FIG. 4 according to a further embodiment of the present disclosure.

FIG. 9 is a circuit diagram of a resonant power converter employing the transformer of FIG. 4 according to another embodiment of the present disclosure.

FIG. 10 is a circuit diagram of a resonant power converter employing the transformer of FIG. 4 according to still another embodiment of the present disclosure.

FIG. 11 is a cross-sectional view of a transformer according to another embodiment of the present disclosure.

FIG. 12 is a circuit diagram of a resonant power converter employing the transformer of FIG. 11 according to another embodiment of the present disclosure.

FIG. 13 is a circuit diagram of a resonant power converter employing the transformer of FIG. 11 according to yet another embodiment of the present disclosure.

Like reference characters indicate like parts or features throughout the several drawings.

### DETAILED DESCRIPTION

Illustrative embodiments of the present disclosure are described below. In the interest of clarity, not all features of an actual implementation are described in this specification. It will be appreciated that in the development of any actual embodiment, numerous implementation-specific decisions must be made to achieve specific goals, such as performance objectives and compliance with system-related, business-related and/or environmental constraints. Moreover, it will be appreciated that such development efforts may be complex and time-consuming, but would nevertheless be a routine undertaking for those of ordinary skill in the art having the benefit of this disclosure.

According to one aspect of the present disclosure, a transformer includes a primary winding, a secondary winding and a transformer core having a first leg, a second leg and a third leg. The second leg is positioned between the first leg and the third leg, and the primary winding is wound around the first leg, the second leg and the third leg.

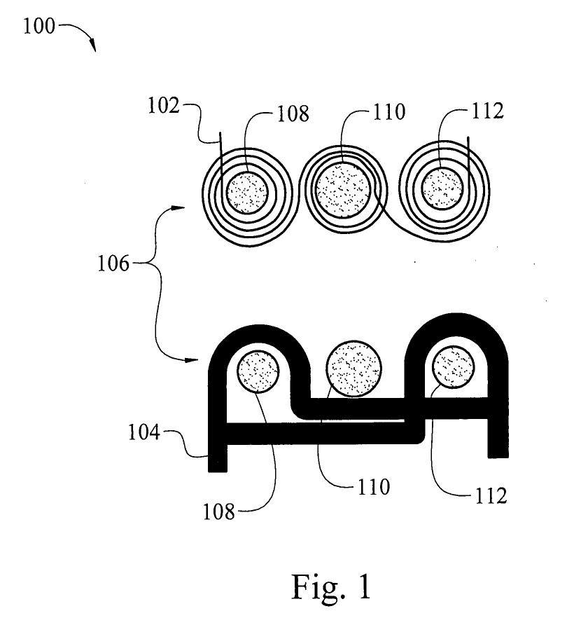

One embodiment of a transformer incorporating this aspect of the present disclosure is indicated generally by reference numeral 100 and will now be described with reference to FIG. 1. The transformer 100 includes a primary winding 102, a secondary winding 104 and a transformer core 106 including a first leg 108, a second leg 110 and a third leg 112. The second leg 110 is positioned between the first leg 108 and the third leg 112. Further, the primary winding 102 is wound in series around the first leg 108, the second leg 110 and the third leg 112.

In addition, the secondary winding 104 is wound in parallel around the first leg 108 and the third leg 112.

The transformer core 106 can be any suitable core having three or more legs such as an EE or EI core. Although FIG. 1 illustrates the primary winding 102 and the secondary winding 104 in separate cross-sectional views, it should be understood that the separate cross-sectional views are for purposes of clarity and that the primary winding 102 and the secondary winding 104 are wound around the same transformer core 106.

In the embodiment of FIG. 1, the number of turns of the primary winding 102 around each leg 108, 110 and 112 can be any suitable number of turns. In some embodiments, the primary winding includes at least three turns, with one turn being wound around each leg 108, 110 and 112. It should be understood, however, that the number of turns around each leg 108, 110 and 112 can be greater than one, and do not have to be equal.

Further, the number of turns of the secondary winding 104 around each of the first leg 108 and the third leg 112 can be any suitable number of turns, such as a single turn. It should be understood, however, that the number of turns could be two or more without departing from the scope of this disclosure.

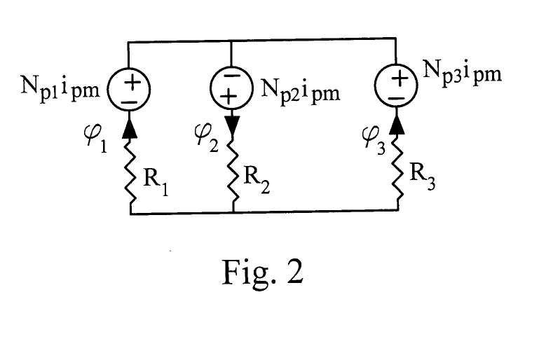

As described below with reference to FIG. 2, winding the primary winding 102 around the legs 108, 110 and 112 and the secondary winding 104 around the legs 108 and 112 produces an advantageous voltage step-down ratio. Referring now to FIG. 2, which illustrates an equivalent magnetic circuit of the transformer 100 when the transformer 100 is operating with an open load, Nₚ₁iₚₘ, Nₚ₂iₚₘ and Nₚ₃iₚₘ represent the magnetomotive force (mmf) in the legs 108, 110 and 112, respectively, where iₚₘ is a magnetizing current and Nₚ₁, Nₚ₂ and Nₚ₃ are numbers of turns of the primary winding 102 around the legs 108, 110 and 112, respectively. Further, φ₁, φ₂ and φ₃ are magnetic fluxes flowing through each leg 108, 110 and 112, respectively. In addition, R₁, R₂ and R₃ are reluctances of each leg 108, 110 and 112 respectively, which can be calculated according to the following equation:

$$R = \frac{{l}_{m}}{μ {A}_{c}} \qquad ( 1 )$$

where lₘ is the length of a magnetic path, μ is permeability and A_{c} is a flux cross-sectional area. With a typical EE or EI core, the reluctances of each leg approximately satisfy the expression:

R₁=R₃=2R₂=2R (2)

Accordingly, the flux flowing through the three legs 108, 110 and 112 can be solved by the following equations:

$$\begin{matrix}{ϕ}_{1} = \frac{{i}_{pm}}{8 R} ( 3 {N}_{p 1} + 2 {N}_{p 2} - {N}_{p 3} ) & ( 3 ) \\ {ϕ}_{2} = \frac{{i}_{pm}}{4 R} ( {N}_{p 1} + 2 {N}_{p2} + {N}_{p 3} ) & ( 4 ) \\ {ϕ}_{3} = \frac{{i}_{pm}}{8 R} ( - {N}_{p 1} + 2 {N}_{p 2} + 3 {N}_{p 3} ) & ( 5 )\end{matrix}$$

Since the secondary winding 104 is wound in parallel around the first leg 108 and the third leg 112, current could circulate internally through the secondary winding 104. To avoid such internally circulating current, the flux φ₁ should be equal to the flux φ₃. Under this condition, and according to equations (3) and (5), the following expression can be obtained:

Nₚ₁=Nₚ₃ (6)

Alternatively, assuming that Nₚ₁=Nₚ₃, the following expression can also be obtained:

$${ϕ}_{1} = {ϕ}_{3} = \frac{1}{2} {ϕ}_{2} \qquad ( 7 )$$

Using the above expressions, a voltage step-down ratio of the transformer 100 can now be determined. More specifically, a primary winding voltage vₚᵣᵢ can be characterized by the following equation:

$${v}_{pri} = {N}_{p 1} \frac{d {ϕ}_{1}}{d t} + {N}_{p 2} \frac{d {ϕ}_{2}}{d t} + {N}_{p 3} \frac{d {ϕ}_{3}}{d t} \qquad ( 8 )$$

and a secondary winding voltage v_{sec} can be characterized by the following equation:

$${v}_{sec} = {N}_{s} \frac{d {ϕ}_{1}}{d t} \qquad ( 9 )$$

where Nₛ is the number of turns of the secondary winding 104 around one of the legs 108 or 112. By substituting expressions (2), (6) and (7), and Nₛ=1 into Equations (8) and (9), the expressions for the primary winding voltage vₚᵣᵢ and the secondary winding voltage v_{sec} become:

$$\begin{matrix}{v}_{pri} = 2 ( {N}_{p 1} + {N}_{p 2} ) \frac{d {ϕ}_{1}}{d t} & ( 10 ) \\ {v}_{sec} = \frac{d {ϕ}_{1}}{d t} & ( 11 )\end{matrix}$$

Accordingly, the voltage step-down ratio can be characterized by the following expression:

$$\frac{{v}_{pri}}{{v}_{sec}} = 2 ( {N}_{p 1} + {N}_{p 2} ) \qquad ( 12 )$$

From the expression (12) it can be seen that an advantageous voltage step-down ratio in the transformer 100 can be achieved. As a result, fewer turns of the primary winding 102 can be employed, while maintaining or even increasing the voltage-step down ratio as compared with other known transformer designs. Furthermore, employing fewer turns of the primary winding 102 reduces copper losses, especially in planar transformers where fewer turns allow copper traces to be wider.

Furthermore, winding the second winding 104 around the first leg 108 and the third leg 112 can also reduce copper losses, since the secondary winding 104 can extend outside the core 106 (i.e., outside a window of the core 106), as opposed to being constrained within the core, which would be the case if the secondary winding 104 were wound only around the second leg 110. Similarly, since parts of the primary winding 102 are wound around the first leg 108 and the third leg 112, copper losses in the primary winding 102 can further be reduced. Thus, it can be seen that in addition to reducing copper losses, advantageous window utilization is achieved.

Winding the secondary winding 104 and parts of the primary winding 102 around the first leg 108 and the third leg 112 can also improve the coupling between the primary winding 102 and the secondary winding 104. Improving this coupling reduces the leakage inductance in the transformer 100. Additionally, it should be noted that adjusting the number of turns of the primary winding 102 around the first leg 108 and the third leg 112 adjusts the leakage inductance. For example, increasing the number of turns of the primary winding 102 around the first leg 108 and the third leg 112 can decrease the leakage inductance. Conversely, reducing the number of turns of the primary winding 102 around the first leg 108 and the third leg 112 can increase the leakage inductance. The adjustability of the leakage inductance can be advantageous in several power converters including full bridge, active-clamp forward DC-to-DC power converters, and resonant converters where the leakage inductance can become a resonant element. Further, the leakage inductance can provide the additional benefit of assisting in achieving zero-voltage switching.

Additionally, it should be noted that since any suitable number of turns of the primary winding 102 and the secondary winding 104 can be employed, the voltage step-down ratio can be adjustable.

Furthermore, because the secondary winding 104 is connected in parallel and wound around the first leg 108 and the third leg 112, balancing the flux between the first leg 108 and the third leg 112 can be achieved, which protects the core legs 108, 110 and 112 from saturation.

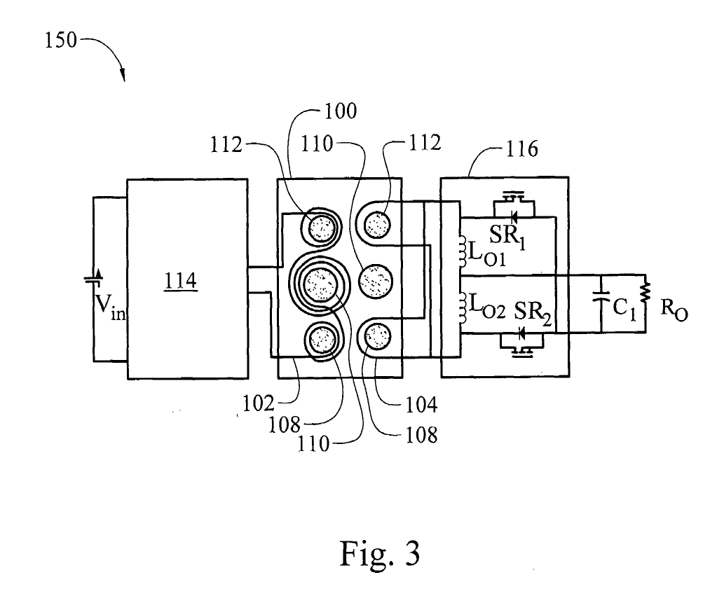

The transformer 100 can be employed, for example, in a power converter 150 as shown in FIG. 3. The power converter 150 includes input terminals for receiving an input voltage Vᵢₙ, a primary switching circuit 114, the transformer 100, a current doubler rectifier 116, an output capacitor C, and output terminals for connecting to an output load Rₒ. The current doubler rectifier 116 includes output inductors Lₒ₁ and Lₒ₂ and synchronous rectifiers SR₁ and SR₂.

The primary switching circuit 114 is coupled between the input voltage Vᵢₙ and the primary winding 102 of the transformer 100. The primary switching circuit 114 can be any suitable switching circuit including, without limitation, a full bridge circuit, half bridge circuit, push pull circuit or forward circuit.

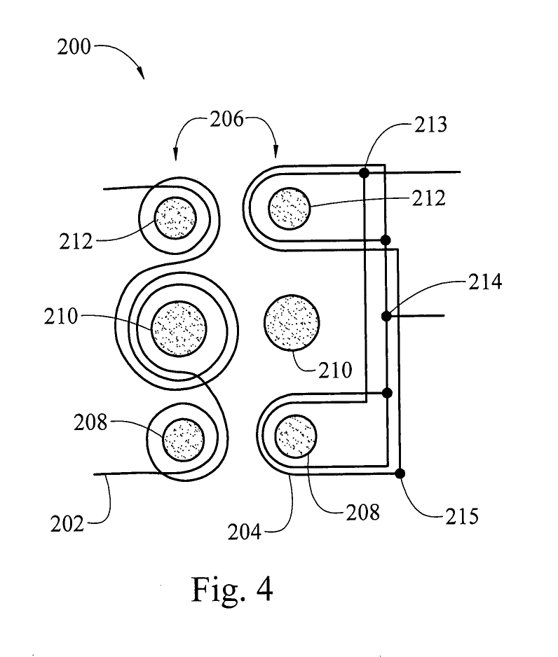

A transformer 200 according to another embodiment of the present disclosure is illustrated in FIG. 4. The transformer 200 includes a primary winding 202, a secondary winding 204 and a transformer core 206 having a first leg 208, a second leg 210 and a third leg 212. Similar to the primary winding 102, the primary winding 202 is wound around the three legs 208, 210 and 212. The secondary winding 204 includes two turns wound around the first leg 208 and two turns wound around the third leg 212. The windings around the first leg 208 and the third leg 212 are connected in parallel at a terminal 214.

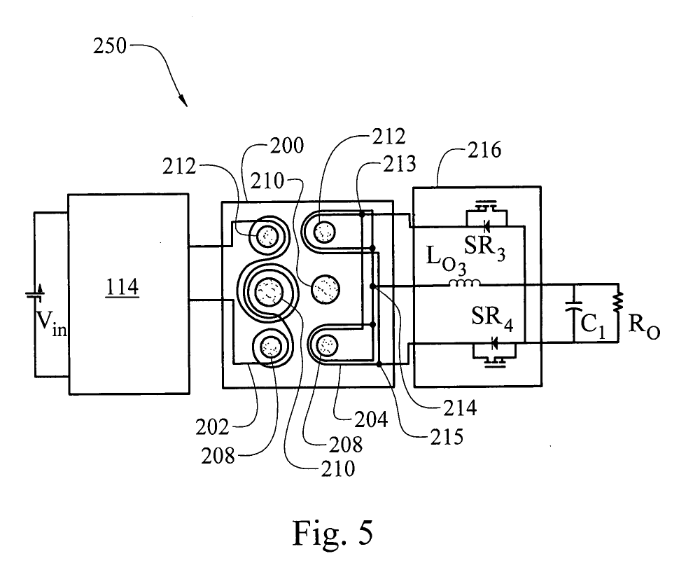

In addition, the secondary winding 204 also includes terminals 213 and 215 that, along with the terminal 214, can allow the secondary winding 204 to be coupled to a center-tapped rectifier as shown, e.g., in FIGS. 5-10.

For example, FIG. 5 illustrates a power converter 250 including the transformer 200. Similar to the power converter 150, the power converter 250 includes an input voltage Vᵢₙ, a primary circuit 114, an output capacitor C₁ and an output load Rₒ. In addition, the power converter 250 includes a center-tapped rectifier 216 coupled to the secondary winding 204 via the terminals 213 215. The center-tapped rectifier 216 includes an output inductor Lₒ₃ and two synchronous rectifiers SR₃ and SR₄. The primary circuit 114 is coupled between the input voltage Vᵢₙ and the primary winding 202 of the transformer 200.

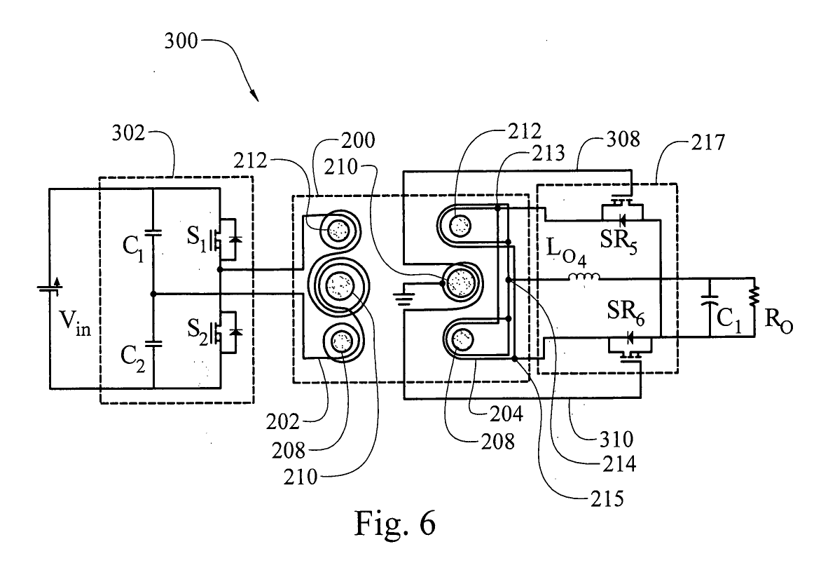

FIG. 6 illustrates another power converter 300 employing the transformer 200. Similar to the power converters described above, the power converter 300 includes an input voltage Vᵢₙ, an output capacitor C, and an output load Rₒ. The power converter 300 further includes a half bridge circuit 302, which includes capacitors C₁ and C₂, and power switches S₁ and S₂, coupled to the primary winding 202. Further, the power converter 300 includes a center-tapped rectifier 217, which includes an output inductor Lₒ₄ and synchronous rectifiers SR₅ and SR₆ coupled to the secondary winding 204. Additionally, the power converter 300 further includes driving windings 308 and 310 wound around the second leg 210 for driving the synchronous rectifiers SR₅ and SR₆, respectively.

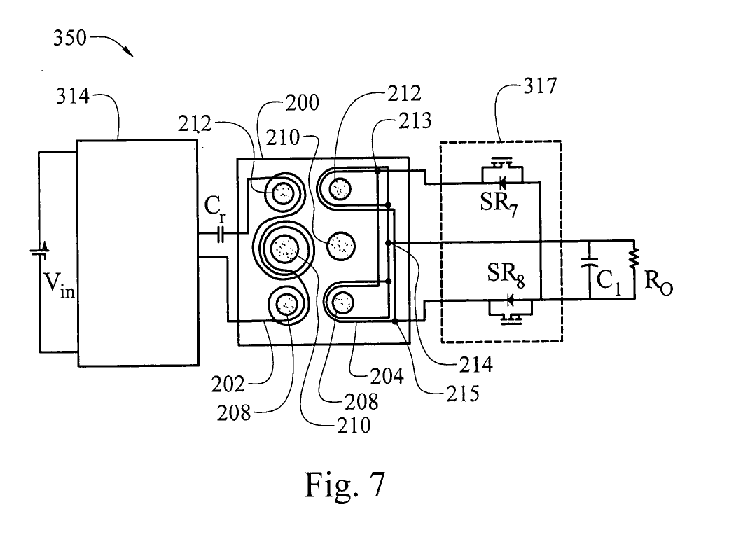

FIG. 7 illustrates a resonant power converter 350 employing the transformer 200. Similar to some of the power converters described above, the resonant power converter 350 includes an input voltage Vᵢₙ, the transformer 200, an output capacitor C₁ and an output load Rₒ. Further, the resonant power converter 350 includes a resonant capacitor Cᵣ and a primary circuit 314 coupled between the primary winding 202 and the input voltage Vᵢₙ. Additionally, a center-tapped rectifier 317, which includes synchronous rectifiers SR₇ and SR₈, are coupled to the secondary winding 204.

Similar to the primary circuit 114, the primary circuit 314 can be any suitable switching circuit including, for example, a full bridge circuit, half bridge circuit, push pull circuit or forward circuit.

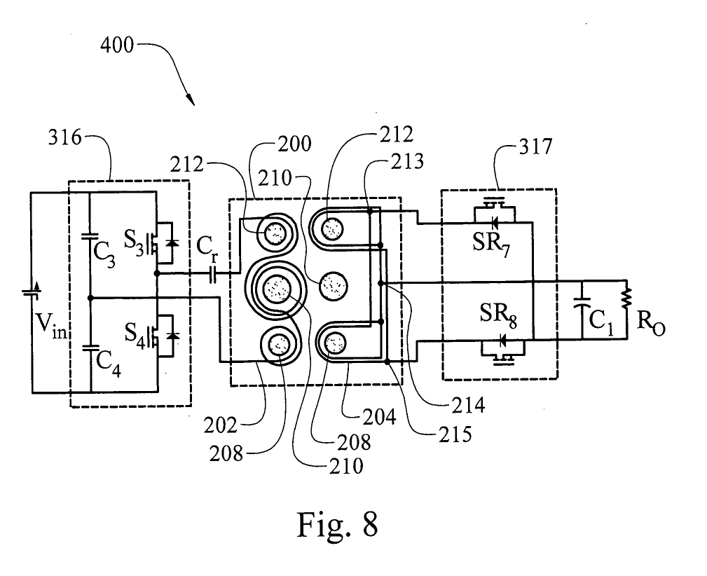

As one example, FIG. 8 illustrates a resonant power converter 400 employing a half bridge circuit 316, which includes capacitors C₃ and C₄, and power switches S₃ and S₄.

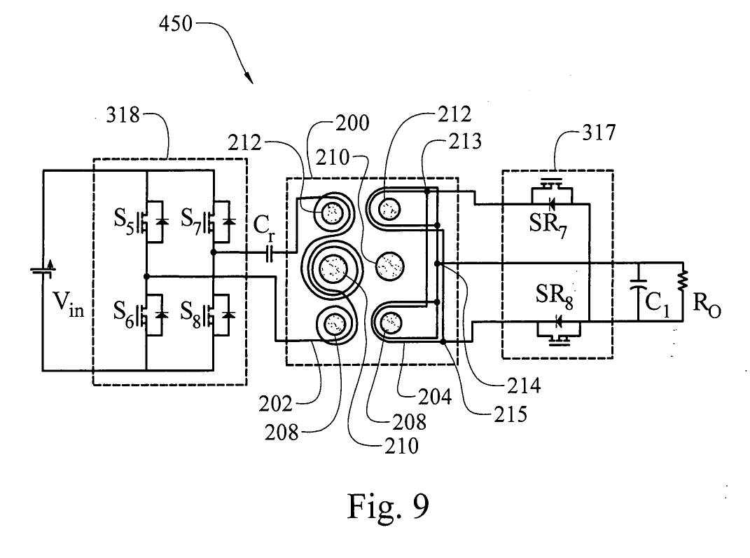

FIG. 9 illustrates a resonant converter 450 similar to the resonant converter 400, except that the resonant converter 450 includes a full bridge circuit 318, which includes power switches S₅-S₈.

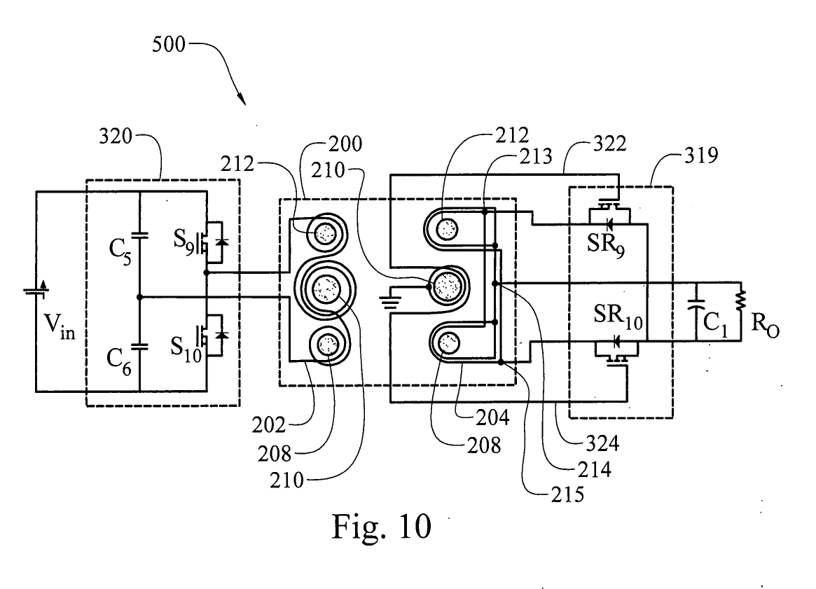

FIG. 10 illustrates another embodiment of a resonant power converter 500 employing the transformer 200. The resonant power converter 500 includes a half bridge circuit 320, which includes capacitors C₅ and C₆, and power switches S₉ and S₁₀, coupled to the primary winding 202. Further, the power converter 500 includes a center-tapped rectifier 319, which includes synchronous rectifiers SR₉ and SR₁₀ coupled to the secondary winding 204. Additionally, the power converter 500 includes driving windings 322 and 324 wound around the second leg 210 for driving the synchronous rectifiers SR₉ and SR₁₀, respectively.

According to another aspect of the present disclosure, a resonant power converter includes a transformer having a primary winding, a secondary winding and a transformer core having a first leg, a second leg and a third leg. The second leg is positioned between the first and the third leg, and the primary winding is wound around the second leg.

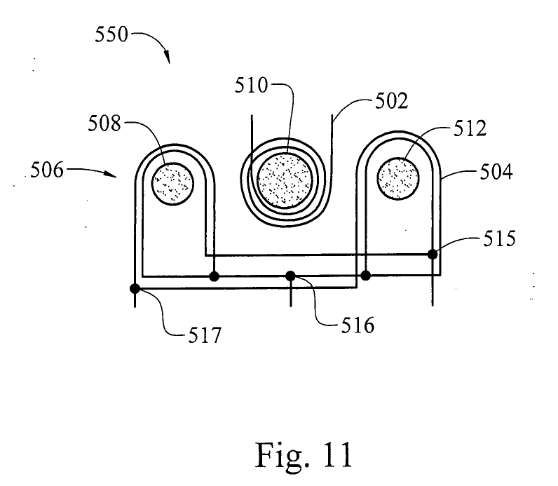

An embodiment of a transformer incorporating this aspect of the present disclosure will now be described with reference to FIG. 11. The transformer 550 includes a primary winding 502, a secondary winding 504 and a transformer core 506 including a first leg 508, a second leg 510 and a third leg 512. The second leg 510 is positioned between the first leg 508 and the third leg 512. Additionally, the primary winding 502 is wound around the second leg 510.

In the embodiment of FIG. 11, the secondary winding 504 includes three terminals 515-517 for connecting to a center-tapped rectifier.

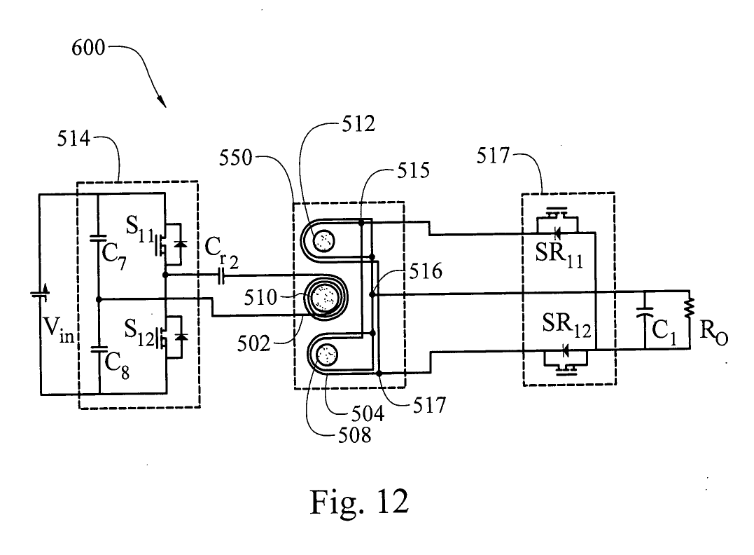

FIG. 12 illustrates a resonant power converter 600 employing the transformer 550 of FIG. 11. As shown in FIG. 12, the resonant power converter 600 includes an input voltage Vᵢₙ, an output capacitor C₁ and an output load Rₒ. Further, the resonant power converter 600 includes a resonant capacitor Cᵣ₂ and a half bridge circuit 514 including power switches S₁₁ and S₁₂ and capacitors C₇ and C₈ coupled between the input voltage Vᵢₙ and the primary winding 502. Additionally, a center-tapped rectifier 517 including synchronous rectifiers SR₁₁ and SR₁₂ are coupled to the secondary winding 504.

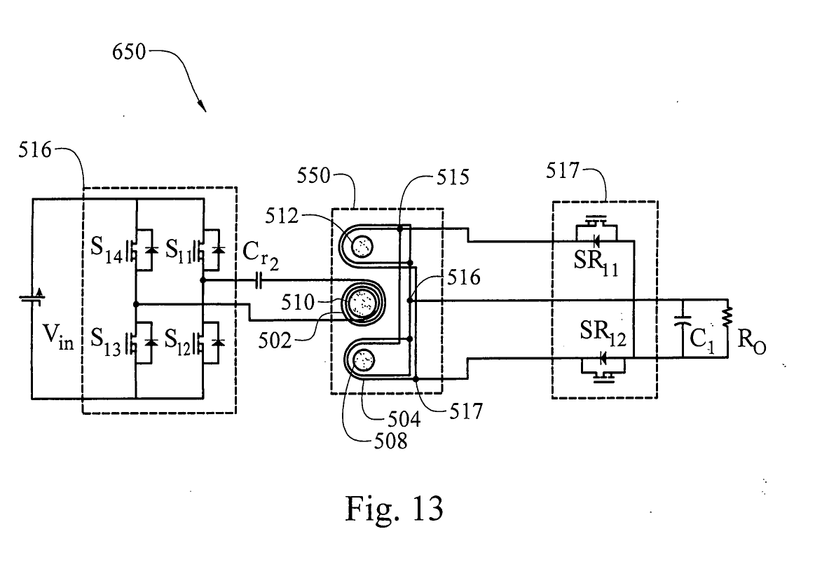

FIG. 13 illustrates a resonant converter 650 similar to the resonant converter 600, except the resonant converter 650 includes a full bridge circuit 516 including power switches S₁₁-S₁₄.

In alternative embodiments, the half bridge circuit 514 and the full bridge circuit 516 of the resonant converters 600 and 650, respectively, could be other suitable switching circuits including, for example, a push pull circuit or forward circuit.

It should be noted that the resonant converters 350, 400, 450, 500, 600 and 650 do not include an output inductor. This is because the transformer leakage inductance functions like a resonant element. Accordingly, employing a separate output inductor in such resonant converters is oftentimes unnecessary. Furthermore, in certain situations such as when the transformer 200 has a current source output, the center-tapped rectifiers 317 and 319 do not always require a filter inductor.

One or more of the transformers described above can also be used in DC-to-DC PWM power converters, bus converters, power converters employing class E topology, and other suitable power converters without departing from the scope of this disclosure. Further, such converters can employ any suitable rectifiers including those described above, as well as full bridge and voltage doubler rectifiers.

What is claimed is:

1. A transformer comprising a primary winding, a secondary winding, and a transformer core having a first leg, a second leg and a third leg, the second leg positioned between the first and the third leg, the primary winding wound around the first leg, the second leg and the third leg.

2. The transformer of claim 1 wherein the secondary winding is wound around the first and the third legs.

3. The transformer of claim 2 wherein a number of turns of the primary winding wound around the first leg is equal to a number of turns of the primary winding wound around the third leg.

4. The transformer of claim 3 wherein vₚᵣᵢ is a primary winding voltage, v_{sec} is a secondary winding voltage, Nₒ is a number of turns of the primary winding wound around one of the outer legs and N_{c} is a number of turns of the primary winding wound around the center leg, and a transformer voltage-step-down ratio is:
$$\frac{{v}_{pri}}{{v}_{sec}} = 2 ( {N}_{o} + {N}_{c} )$$

5. The transformer of claim 2 wherein the primary winding is wound in series.

6. The transformer of claim 2 wherein the primary winding includes at least three turns, with one turn wound around the first leg, the second leg and the third leg.

7. The transformer of claim 6 wherein at least two turns of the secondary winding are wound around the first and the third leg.

8. The transformer of claim 2 wherein the secondary winding is wound in parallel.

9. A power converter comprising the transformer of claim 1.

10. A power converter comprising a primary winding, a secondary winding, a rectifier coupled to the secondary winding, and a transformer core having a first leg, a second leg and a third leg, the second leg positioned between the first and the third leg, the primary winding wound around the first leg, the second leg and the third leg.

11. The power converter of claim 10 wherein the rectifier is a current doubler rectifier.

12. The power converter of claim 10 wherein the rectifier is a center-tapped rectifier.

13. The power converter of claim 10 wherein the secondary winding includes self-driven windings for controlling the rectifier.

14. The power converter of claim 10 wherein the power converter includes a full bridge circuit coupled to the primary winding.

15. The power converter of claim 10 wherein the power converter includes a half bridge circuit coupled to the primary winding.

16. The power converter of claim 10 wherein the power converter includes a push pull circuit coupled to the primary winding.

17. The power converter of claim 10 wherein the power converter includes a forward circuit coupled to the primary winding.

18. The power converter of claim 10 wherein the power converter is a resonant converter.

19. The power converter of claim 18 wherein the power converter does not include an output inductor.

20. The power converter of claim 10 wherein the secondary winding is wound around the first and the third legs.

21. The power converter of claim 20 wherein the secondary winding is wound in parallel.

22. A resonant power converter comprising a transformer having a primary winding, a secondary winding, and a transformer core having a first leg, a second leg and a third leg, the second leg positioned between the first and the third leg, the primary winding wound around the second leg.

23. The power converter of claim 22 wherein the primary winding is not wound around the first and the third leg.

24. The power converter of claim 23 further comprising a rectifier coupled to the secondary winding.

25. The power converter of claim 24 wherein the rectifier is a center-tapped rectifier.

26. The power converter of claim 25 wherein the secondary winding includes self-driven windings for controlling the rectifier.

27. The power converter of claim 23 wherein the power converter includes a full bridge circuit coupled to the primary winding.

28. The power converter of claim 23 wherein the power converter includes a half bridge circuit coupled to the primary winding.

29. The power converter of claim 23 wherein the power converter includes a push pull circuit coupled to the primary winding.

30. The power converter of claim 23 wherein the power converter includes a forward circuit coupled to the primary winding.

31. The power converter of claim 23 wherein the power converter does not include an output inductor.
